(19) United States
(12) Patent Application Publication
(10) Pub. No.: US 2013/0336432 A1
(43) Pub. Date: Dec. 19, 2013

(54) METHODS AND SYSTEMS FOR PROCESSING A DIGITAL SIGNAL BY ESTIMATING SIGNAL ENERGY AND NOISE POWER DENSITY

(71) Applicants: Randy Lee Turcotte, Tempe, AZ (US); Christopher Lew Woodland, Gilbert, AZ (US); Nina Tina Murphy, Phoenix, AZ (US); Thomas Ohe, Tempe, AZ (US)

(72) Inventors: Randy Lee Turcotte, Tempe, AZ (US); Christopher Lew Woodland, Gilbert, AZ (US); Nina Tina Murphy, Phoenix, AZ (US); Thomas Ohe, Tempe, AZ (US)

(73) Assignee: GENERAL DYNAMICS C4 SYSTEMS, INC., Scottsdale, AZ (US)

(21) Appl. No.: 13/527,461

(22) Filed: Jun. 19, 2012

(51) Int. Cl. H04B 1/10

(52) U.S. Cl. 375/346

(57) ABSTRACT

Systems and methods are described for processing a digital signal. In one embodiment, the method comprises receiving time-aligned input samples of an input signal; computing at least one moment using the time-aligned input samples; determining at least one of signal energy per symbol and noise power spectral density based on the at least one moment; and adjusting an input signal level based on the at least one of the signal energy per symbol and the noise power spectral density.

### TECHNICAL FIELD

The present disclosure generally relates to methods and systems for signal processing, and more particularly relates to methods and systems for signal processing for parameters used in demodulation systems.

### BACKGROUND

In systems that provide coherent demodulation of digital signals such as, but not limited to, Minimum Phase Shift Keying (MPSK), Minimum Shift Keying (MSK), and Gaussian Minimum Shift Keying (GMSK), the received signal must be properly aligned to a set of decision thresholds for optimum performance. Techniques to properly set a signal power as the input of a decision device typically require that both timing and carrier coherence are established prior to adjusting the signal level for optimum detection. However, many demodulator architectures allow for the establishment of signal timing prior to establishing carrier coherency.

As a result, it is desirable to provide methods and systems for processing the time-aligned signals prior to establishing carrier coherency to optimize the performance of the demodulator. Other desirable features and characteristics will become apparent from the subsequent detailed description and the appended claims, taken in conjunction with the accompanying drawings and this background of the invention.

### BRIEF SUMMARY

According to various exemplary embodiments, systems and methods are described for processing a digital signal. In one embodiment, the method comprises receiving time-aligned input samples of an input signal; computing at least one moment using the time-aligned input samples; determining at least one of signal energy per symbol and noise power spectral density based on the at least one moment; and adjusting an input signal level based on the at least one of the signal energy per symbol and the noise power spectral density.

In another embodiment, a system is provided for processing a digital signal. The system includes a first module that computes at least one moment using time-aligned input samples. A second module determines at least one of signal energy per symbol and noise power spectral density based on the at least one moment. A third module adjusts an input signal level based on the at least one of the signal energy per symbol and the noise power spectral density.

In yet another embodiment, a computer program product is provided for processing a digital signal. The computer program product comprises a tangible storage medium readable by a processing circuit and storing instructions for execution by the processing circuit for performing a method comprising: receiving time-aligned input samples of an input signal; computing at least one moment using the time-aligned input samples; determining at least one of signal energy per symbol and noise power spectral density based on the at least one moment; a adjusting an input signal level based on the at least one of the signal energy per symbol and the noise power spectral density.

Other embodiments, features and details are set forth in additional detail below.

### BRIEF DESCRIPTION OF THE DRAWINGS

The present invention will hereinafter be described in conjunction with the following figures, wherein like numerals denote like elements, and

FIG. 1 is a functional block diagram illustrating a demodulator system including an estimation module in accordance with exemplary embodiments;

FIG. 2 is a more detailed block diagram illustrating an estimation module of the demodulator system in accordance with exemplary embodiments; and

FIG. 3 is a flowchart illustrating an estimation method that may be performed by the demodulator system in accordance with exemplary embodiments.

### DETAILED DESCRIPTION

The following detailed description of the invention is merely example in nature and is not intended to limit the invention or the application and uses of the invention. Furthermore, there is no intention to be bound by any theory presented in the preceding background or the following detailed description. As used herein, the term “module” refers to any hardware, software, firmware, electronic control component, processing logic, and/or processor device, individually or in any combination, including, without limitation: an application specific integrated circuit (ASIC), an electronic circuit, a processor (shared, dedicated, or group) and memory that executes one or more software or firmware programs, a combinational logic circuit, and/or other suitable components that provide the described functionality.

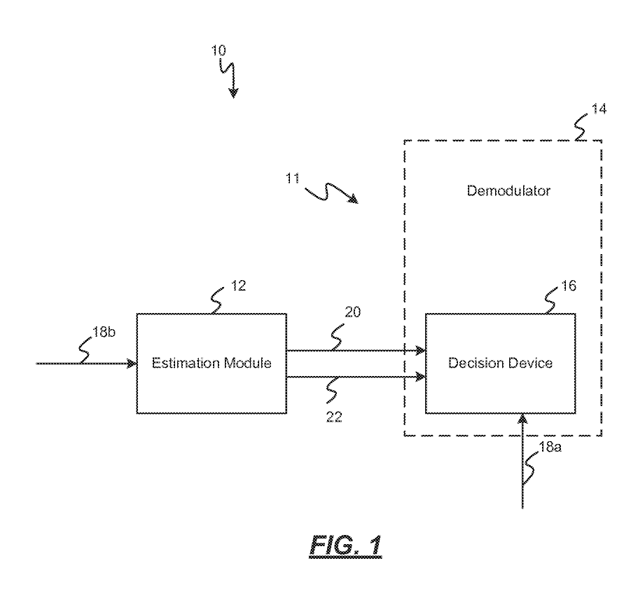

Turning now to the figures and with initial reference to FIG. 1, a parameter estimation system 10 is shown to be associated with a demodulator system 11 in accordance with exemplary embodiments. As can be appreciated, the parameter estimation system 10 of the present disclosure is applicable to various signal processing systems such as, but not limited to, other demodulation systems, antenna processing systems, signal diversity combining systems, multiple input and multiple output antenna processing systems, open loop power control systems, and closed loop power control systems, and is not limited to the present example. For exemplary purposes, the disclosure will be discussed in the context of the demodulator system 11.

In various embodiments, the demodulator system 11 includes a demodulator 14 having a data decision device 16 that processes an input signal 18a. The demodulator 14 is a digital signal processor such as, but not limited to a MPSK demodulator, a MSK demodulator, and a GMSK demodulator.

The parameter estimation system 10 includes an estimation module 12. The estimation module 12 processes an input signal 18b to estimate the signal energy per symbol (Es) 20 and the noise power spectral density (No) 22. The input signal 18b includes time-aligned samples of the input signal 18a. The samples are time aligned but have not established carrier coherency. For example, the estimation module 12 estimates the Es 20 and the No 22 based on a relationship between characteristics of several moments and by a manipulation of these moments so that noise-only and signal-only moments become separable. By doing so, the estimation is made prior to carrier coherence tracking.

The estimated signals Es 20 and No 22 are then used to adjust the input signal 18a to the data decision device 16 and/or the demodulator 14. In particular, the estimated signals 20, 22 can be used to set a signal level at the input to one or both of the data decision device 16 and the demodulator 14.

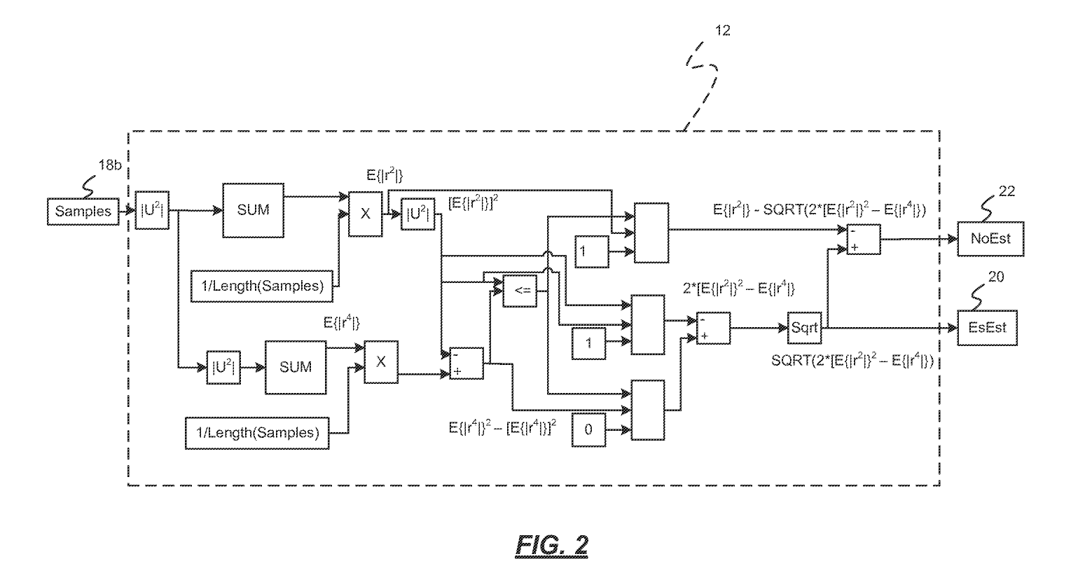

Referring now to FIG. 2, a more detailed block diagram illustrates exemplary embodiments of the estimation module 12. In various embodiments, the estimations performed by the estimation module 12 may be based upon fourth-order signal characteristics. For example, let the input 18b be:

r=s+n,

where s is the signal component, and n is the noise component. The model illustrates a processing method that separates signal characteristics from noise characteristics using time-based averages which are assumed to be equivalent to ensemble averages of the estimator.

In FIG. 2, the estimation module 12 computes a second moment of the received signal. For example, by taking the magnitude square of the individual samples of the received signal and averaging over a predetermined number of the sample yields:

E{|r|²}=E{|s|²+s*n+sn*+|n|²}=E{|s|²}+E{|n|²}=m_{2ss*}+m_{2nn*}E{|r|²}=σₛ²+σₙ². (1)

The fourth-moment of the received signal is then computed as:

$$\begin{matrix}E \{ {\vert r \vert}^{4} \} = E \{ {\vert s \vert}^{4} + {\vert s \vert}^{2} {s}^{*} n + {\vert s \vert}^{2} {sn}^{*} + {\vert s \vert}^{2} {\vert n \vert}^{2} \} \\ = E \{ {sn}^{*} {\vert s \vert}^{2} + {sn}^{*} {s}^{*} n + {sn}^{*} {sn}^{*} + {sn}^{*} {\vert n \vert}^{2} \} \\ = E \{ {s}^{*} n {\vert s \vert}^{2} + {s}^{*} n {s}^{*} n + {s}^{*} n {sn}^{*} + {s}^{*} n {\vert n \vert}^{2} \} \\ = E \{ {\vert n \vert}^{2} {\vert s \vert}^{2} + {\vert n \vert}^{2} {s}^{*} n + {\vert n \vert}^{2} {sn}^{*} + {\vert n \vert}^{2} {\vert n \vert}^{2} \}\end{matrix} \\ E \{ {\vert r \vert}^{4} \} = E \{ {\vert s \vert}^{4} \} + 4 E \{ {\vert s \vert}^{2} \} E \{ {\vert n \vert}^{2} \} + E \{ {\vert n \vert}^{4} \} . \qquad ( 2 )$$

In moment notation, specifically noting which components are conjugated and which are not provides:

E{|r|⁴}=m_{ss*ss*}+4m_{ss*}m_{nn*}+m_{nn*nn*}. (3)

To estimate the Es consider:

2E{|r|²}²−E{|r|⁴}=2m_{2ss*}m_{2ss*}+4m_{2ss*}m_{2nn*}+2m_{2nn*}m_{2nn*}−m_{ss*ss*}−4m_{ss*}m_{nn*}−m_{nn*nn*}. (4)

A zero-mean Gaussian process provides:

m_{nn*nn*}=−2m_{nn*}m_{nn*} (5)

(5)

Substituting equation 5 into equation 4 provides:

2E{|r|²}²−E{|r|⁴}=2m_{2ss*}m_{2ss*}−m_{ss*ss*}. (6)

For constant envelope signals and operation on samples at the output of the matched filter provides:

2E{|r|²}²−E{|r|⁴}=2m_{2ss*}m_{2ss*}−m_{2ss*}=σₛ⁴. (7)

Thus, the normalized sampling provides:

\sqrt{2E{|r|²}²−E{|r|⁴}}=\sqrt{σₛ⁴}=σₛ²=Eₛ. (8)

The Es 20 can then be subtracted from the second moment to determine No 22 as subtracting equation 8 from equation 1 and considering operation on one sample per symbol provides:

E{|r|²}−\sqrt{2E{|r|²}²−E{|r|⁴}}=σₛ²+σₙ²−σₛ²=Eₛ+N₀−Eₛ=N₀. (9)

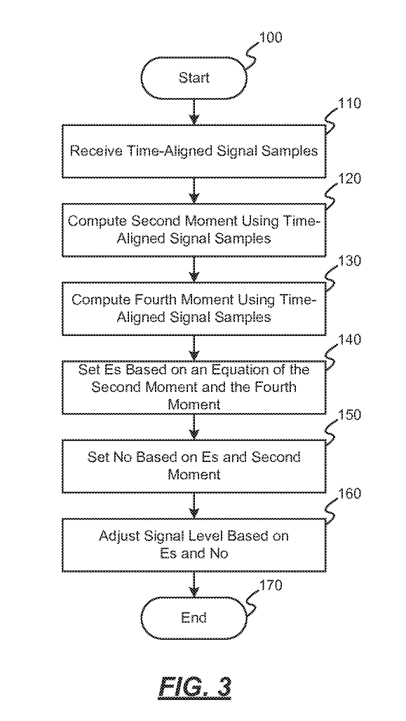

Referring now to FIG. 3, and with continued reference to FIGS. 1 and 2, a flowchart illustrates an estimation method that can be implemented by the parameter estimation system 10 of FIG. 1 in accordance with the present disclosure. As can be appreciated in light of the disclosure, the order of operation within the method shown in FIG. 3 is not limited to the sequential execution as illustrated in FIG. 3, but may be performed in one or more varying orders as applicable and in accordance with the present disclosure. As can further be appreciated, one or more steps of the method may be added or deleted without altering the spirit of the method.

In various embodiments, the estimation method may be scheduled to run at various time intervals and/or may be run based one or more predetermined events.

In one example, the method may begin at 100. The time-aligned samples of the signal 18b are received at 110. The second moment of the received signal is computed using the time-aligned samples 18b and, for example, equation 1 above at 120. The fourth moment of the received signal is computed using the time-aligned samples 18b and, for example, equation 3 above at 130. The Es 20 is set to an algebraic equation of the fourth and second moments of the received signal at 140. The No 22 is computed by subtracting the Es 20 from the second moment of the received signal, for example, using equation 9 at 150. The Es 20 and No 22 are then used to optimize the input signal 18a, for example, by using the values 20, 22 to adjust the input signal power to the modulator 14 at 160. Thereafter, the method may end at 170.

As can be appreciated, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

While at least one example embodiment has been presented in the foregoing detailed description of the invention, it should be appreciated that a vast number of equivalent variations exist. It should also be appreciated that the embodiments described above are only examples, and are not intended to limit the scope, applicability, or configuration of the invention in any way. Rather, the foregoing detailed description will provide those skilled in the art with a convenient road map for implementing various examples of the invention. It should be understood that various changes may be made in the function and arrangement of elements described in an example embodiment without departing from the scope of the invention as set forth in the appended claims and their legal equivalents.

What is claimed is:

1. A method of processing a digital signal, comprising:
receiving time-aligned input samples of an input signal;
computing at least one moment using the time-aligned input samples;
determining at least one of signal energy per symbol and noise power spectral density based on the at least one moment; and
adjusting an input signal level based on the at least one of the signal energy per symbol and the noise power spectral density.

2. The method of claim 1 wherein the computing the at least one moment comprises computing a fourth order moment using the time-aligned input samples.

3. The method of claim 2 wherein the determining comprises determining the signal energy per symbol based on the fourth order moment.

4. The method of claim 2 wherein the computing the at least one moment further comprises computing a second order moment using the time-aligned input samples.

5. The method of claim 4 wherein the determining comprises determining the noise power spectral density based on the fourth order moment and the second order moment.

6. The method of claim 5 wherein the determining further comprises determining the signal energy per symbol based on an equation of the fourth order moment and the second order moment.

7. The method of claim 6 wherein the determining comprises determining the noise power spectral density by subtracting the signal energy per symbol from the second order moment.

8. The method of claim 1 further comprising processing the input signal by a demodulator after the adjusting.

9. The method of claim 1 wherein the time-aligned input signals are not carrier coherent.

10. A system for processing a digital signal, comprising:
a first module that computes at least one moment using time-aligned input samples;
a second module that determines at least one of a signal energy per symbol and a noise power spectral density based on the at least one moment; and
a third module that adjusts an input signal level based on the at least one of the signal energy per symbol and the noise power spectral density.

11. The system of claim 10 wherein the first module computes a fourth order moment using the time-aligned input samples.

12. The system of claim 11 wherein the second module determines the signal energy per symbol based on the fourth order moment.

13. The system of claim 11 wherein the first module computes a second order moment using the time-aligned input samples.

14. The system of claim 13 wherein the second module determines the noise power spectral density based on the fourth order moment and the second order moment.

15. The system of claim 14 wherein the second module determines the signal energy per symbol based on an equation of the fourth order moment and the second order moment.

16. The system of claim 15 wherein the second module determines the noise power spectral density by subtracting the signal energy per symbol from the second order moment.

17. The system of claim 10 further comprising a demodulator that processes the input signal the input signal is adjusted.

18. The system of claim 10 wherein the time-aligned input signals are not carrier coherent.

19. A computer program product for processing a digital signal, comprising:
a tangible storage medium readable by a processing circuit and storing instructions for execution by the processing circuit for performing a method comprising:
receiving time-aligned input samples of an input signal;
computing at least one moment using the time-aligned input samples;
determining at least one of signal energy per symbol and noise power spectral density based on the at least one moment; and
adjusting an input signal level based on the at least one of the signal energy per symbol and the noise power spectral density.
